(19) United States
(12) Patent Application Publication
(10) Pub. No.: US 2024/0101794 A1
(43) Pub. Date: Mar. 28, 2024

(54) Bioplastic composition, bioplastic product including the same and relative production process

(71) Applicant: FLEXSEA LTD., London Greater London (GB)

(72) Inventor: Carlo FEDELI, London Greater London (GB)

(73) Assignee: FLEXSEA LTD., London Greater London (GB)

(21) Appl. No.: 18/263,025

(22) PCT Filed: Feb. 1, 2022
(86) PCT No.: PCT/IB2022/050863

§ 371 Date: Jul. 26, 2023

(30) Foreign Application Priority Data
Feb. 2, 2021 (IT) 102021000002231

(51) Int. Cl. C08L 5/00; C08B 37/00; C08J 5/18; C08K 13/02

(52) U.S. Cl. CPC C08L 5/00; C08B 37/0039; C08J 5/18; C08K 13/02; C08K 5/098

(57) ABSTRACT

The bioplastic composition comprises: at least one seaweed extract in a concentration by weight comprised between 30% and 80% with respect to the weight of the bioplastic composition; water in a concentration by weight comprised between 1% and 30% with respect to the weight of the bioplastic composition; at least four additives present in a total concentration by weight comprised between 20% and 70% with respect to the weight of the bioplastic composition; wherein the additives comprise at least one plasticizer, at least one antimicrobial agent, at least one gelling agent and at least one adjuvant.

### TECHNICAL FIELD

The present invention relates to a bioplastic composition, bioplastic product including the same and relative production process.

### BACKGROUND ART

Most industrial sectors are involved in the production or use of items made from plastic materials. In particular, among these, the disposable items sector, such as e.g. household containers or tableware, and the packaging sector are the largest users of plastic materials in their production cycles.

The most frequently used materials are synthetic polymers which are derived from petroleum such as, e.g., polyethylene (PE), polyethylene terephthalate (PET), polyvinyl chloride (PVC), polypropylene (PP) and others.

These materials have many advantages, including the fact that they are strong, flexible and can be easily worked, e.g. by forming in moulds or spreading in thin films, in order to obtain products of predefined shape, and/or by heat-sealing, in order to obtain items for packaging, such as sachets and bags.

It is well known, however, that these materials have a high environmental impact and their extensive use greatly affects pollution, both in terms of the production cycle and their subsequent disposal.

Plastic materials, in fact, in addition to being extremely polluting in themselves, require a production cycle that is in turn very polluting, which involves the use of toxic/harmful substances for the environment and for animal organisms.

On average, 380 million tons of plastics are produced each year, involving the use of more than 1.2 billion barrels of crude petroleum to produce them. Of that 380 million, nearly 50% of packaging items are disposable, and those numbers are estimated to triple by 2050.

Known plastic materials, when dispersed in the environment, have an average lifetime of 100-1000 years. During this time, known plastic materials tend to break down into infinitesimally small plastic fragments, so-called micro and nano plastics.

These micro and nano plastics almost always end up in the oceans and seas and become part of the food chain, being bio-accumulated in the tissues of animals that feed on them and, consequently, of man, with consequent significant adverse effects on the health of the latter.

In the Mediterranean Sea, the ratio of micro and nano plastics to plankton is 1:2.

A recent study found that 25% of fish sold in global markets are contaminated with micro plastics and show traces of them in the digestive tract. This fish is used for human consumption, as livestock feed or as fertilizer for plants.

At the same time, the recycling process of conventional plastic materials is not always possible because the disposed items are often dirty or made from combinations of different materials that cannot be separated. Furthermore, in the case of films, the recycling process is not economically viable and, therefore, these are often disposed of directly by incineration.

In addition, recycling of conventional plastic materials is not really “circular” but rather follows a downward spiral pattern which simply postpones the plastic waste problem rather than solving it. In fact, the yield of the plastic recycling process is never 100%, since it requires in any case replenishment with “pure” plastic materials in order to obtain the desired products, while the recycled portion is of lower quality. For example, plastic materials used in direct food applications (assuming they reach recycling facilities in a clean enough state to be recycled) cannot be reused for food applications after being recycled, and so on throughout the life of that plastic material, which will eventually have to be land-filled or incinerated.

In recent years, therefore, there has been an increase in research and development of new plastic materials that have a reduced environmental impact, are effectively recyclable, biodegradable and compo stable.

Among these, oxo-degradable materials are conventional petroleum-based plastics which are composed of up to 5% of an oxidizing agent, which is intended to accelerate the degradation of the plastics. However, the oxidizing agent does not make the petroleum-based plastics more biodegradable.

Moreover, even oxo-degradable plastics are not recyclable due to this oxidative additive.

Bio-blends are composed of conventional petroleum-based plastic materials and of a small percentage of bioplastics, such as e.g. a bioplastic derived from starch.

Bio-PET and bio-PP are conventional polyethylene terephthalate and polypropylene which are derived from esterified vegetable oil sources rather than crude petroleum. However, bio-based does not mean biodegradable, and although bio-PET and bio-PP contain a small fraction of thermoplastic starch or are derived from natural oils, they are chemically identical to their corresponding petroleum-derived counterparts and, therefore, have the same drawbacks.

Finally, recently developed materials comprise bioplastics, which are derived from the direct or indirect fermentation of plant biomass released from food resources. The most common raw materials are corn, sugar cane and beet.

Among bioplastics, the best known is polylactic acid (PLA), which is produced by fermenting starches and sugars from plants such as corn, sugar cane and beet.

PLA is compostable, however, the composting of PLA involves industrial degradation processes which are set up under defined temperature and humidity conditions and in the presence of specialized microorganisms. Therefore, PLA is not compostable using household composting devices.

In addition, the plants used to produce PLA require long periods of growth, with intensive use of fertilizers and pesticides that pollute and eutrophicate watersheds and aquifers.

Again, the use of agricultural land for the production of bioplastics creates a stark conflict between food production for food purposes and plastic/industrial purposes, a conflict that becomes even more serious in places where agricultural production is already limited and/or problematic and poor, in addition to the fact that it requires a large amount of fresh water, an increasingly valuable commodity because it is scarce.

Finally, it should be pointed out that known bioplastics, such as e.g. PLA, if not correctly disposed of, will pollute the recycling processes of conventional petrochemical plastics, thus compromising the recycling process itself. This contamination makes it necessary to incinerate the entire batch of plastic waste to be recycled, otherwise serious damage will be caused to the machinery involved.

Another type of bioplastics is polyhydroxyalkanoates (PHAs).

This type of bioplastics is the only one that actually degrades in nature. However, PHAs have very limited applications due to their high fragility and excessive cost. Despite the fact that the manufacturing process of PHAs is a technology which has been developed and researched since the mid-1970s, PHAs have never been able to reach industrial scale due to their very high production cost (15-20 times higher than conventional plastics). Moreover, PHAs, like other bioplastics, are also derived from the same raw materials (sugar cane, beet, corn . . . ), thus making them unsustainable.

An additional major drawback associated with the use of alternative materials is the fact that, in general, these materials are unsatisfactory with respect to key aspects such as mechanical strength, chemical resistance, barrier properties, large-scale manufacturability and commercial/economic viability, which makes them still uncommon among manufacturers.

There is, therefore, a need for new bioplastic compositions which effectively allows reducing the environmental impact caused by conventional plastic materials and, at the same time, are easily used in industrial applications.

### DESCRIPTION OF THE INVENTION

The main aim of the present invention is to devise a bioplastic composition having physical-mechanical properties comparable to those of conventional plastic materials.

Another object of the present invention is to devise a bioplastic composition which is biodegradable and compo stable in nature while avoiding industrial processes.

A further object of the present invention is to devise a bioplastic composition which will enable the manufacture of bioplastic products which are safe for the consumer.

Still one object of the present invention is to devise a bioplastic composition involving an environmentally friendly, environmentally sustainable and large-scale reproducible production process.

Another object of the present invention is to devise a bioplastic composition which allows the aforementioned drawbacks of the prior art to be overcome within the scope of a simple, rational, easy and effective to use as well as affordable solution.

The aforementioned objects are achieved by the present bioplastic composition having the characteristics of claim 1.

Furthermore, the aforementioned objects are achieved by the present bioplastic product having the characteristics of claim 19.

Finally, the aforementioned objects are achieved by the present production process of a bioplastic product having the characteristics of claim 24.

### EMBODIMENTS OF THE INVENTION

Other characteristics and advantages of the present invention will become more apparent from the description of a preferred, but not exclusive, embodiment of a bioplastic composition.

For convenience purposes, prior to an additional description of the present disclosure, certain terms employed in the description and examples are outlined herein.

The term “bioplastics” refers to a polymeric material which is derived from biological resources and has properties similar to plastics derived from petroleum derivatives. Bioplastic materials can be directly derived from biological material or microorganisms, or they can be obtained by conventional chemical synthesis starting from the corresponding monomers.

The term “seaweed” refers to the term commonly used for several groups of multicellular seaweeds which are typically found in or near the sea or freshwater bodies.

The term “seaweed extract” refers to a polysaccharide separated or isolated from seaweed. Appropriately, the method of separation or isolation is by chemical or physical extraction (e.g., precipitation from alcohol and alkaline hydrolysis). For example, the seaweed extract may be obtained by crushing the seaweed plant, or part thereof, followed by filtration to remove the residual solid seaweed material. Alternatively, it may be obtained by washing the seaweed with a suitable solvent, such as e.g. an alkaline aqueous solution, and by collecting the desired extract as insoluble matter remains. The extract may be subjected to additional purification/separation phases. The seaweed extract may be derived from a plurality of seaweeds belonging to the same genus and/or from seaweeds belonging to different genera.

The term “additives” refers to compounds other than a seaweed extract, which are present in the composition. The additives are preferably of natural origin and may themselves be extracted from seaweeds. In particular, additives are selected among substances approved by international food certification bodies in order to limit the impact on both environment and ecosystems.

The term “including” refers to the fact that any of the aforementioned elements is necessarily included and other elements may optionally be included.

The term “biodegradable” refers to a product which is capable of being chemically and/or physically broken down in nature and/or by the action of living beings. The term is used herein to refer to compositions, or components within compositions, which naturally decompose into harmless constituents in water or aqueous or moist environments, typically through the action of microorganisms such as bacteria or fungi.

The term “compostable” refers to the fact that, after being degraded, a product is broken down into nutrients which can be used to enrich the soil.

The term “edible” refers to a non-hazardous substance within daily intake limits which are regulated and approved by bodies such as EFSA and/or FDA which can be ingested by a human being or an animal without adverse effects or posing a health risk.

The composition comprises:
at least one seaweed extract in a concentration by weight comprised between 30% and 80% with respect to the weight of the bioplastic composition;
water in a concentration by weight comprised between 1% and 30% with respect to the weight of the bioplastic composition;
at least four additives present in a total concentration by weight comprised between 20% and 70% with respect to the weight of the bioplastic composition.

Seaweed extracts contribute to making the composition remarkably sustainable. Seaweeds, in fact, do not require extensive exploitation of land or the use of fresh water or fertilizers and pesticides. Moreover, seaweeds generally have rather short life cycles and therefore can be cultivated in an intensive way.

Preferably, the seaweed extract is derived from cultivated seaweeds, in order not to impact the aquatic ecosystem. Moreover, cultivation is advantageous because, depending on the species cultivated, seaweeds capture carbon dioxide in an amount comprised between 5 ton and 10 ton per cultivated hectare, per year.

Advantageously, the seaweed extract comprises at least one of: carrageenan, agar, alginate, fucoidan or a combination thereof.

Carrageenan is a high molecular weight polysaccharide given by the repetition of units of galactose and 3,6-anhydrogalactose, possibly sulfated and joined together by means of glycosidic bonds.

Carrageenan is in the form of different molecular structures which differ from each other by the number and location of sulfate groups and by the bond that joins the single monomers, influencing the properties thereof.

Agar is a polysaccharide given by the repetition of units of agarose and agaropectin. Agarose is a linear polysaccharide polymer composed of the repetition of agarobiose units, a disaccharide in turn composed mainly of D-galactose units. Agaropectin is a polymer given by the repetition of units of pyruvic acid and glucuronic acid.

Alginate is a polysaccharide given by the repetition of units of D-mannuronic acid and L-guluronic acid and which has a high thickening and gelling power. Fucoidan is, in turn, a polysaccharide given by the repetition of units of fucose and other sugars comprising galactose, xylose, arabinose.

The bioplastic composition may comprise a combination of two or more seaweed extracts. In fact, the combination of two or more seaweed extracts may allow obtaining significantly improved properties compared to simply combining the properties obtained by using the same seaweed extracts individually.

Preferably, the bioplastic composition comprises a combination of carrageenan and agar.

In particular, carrageenan is selected from the list comprising: iota carrageenan, lambda carrageenan, kappa carrageenan and a combination thereof.

Preferably, the carrageenan is kappa carrageenan. Kappa carrageenan forms strong and durable gels, especially in the presence of potassium ions. In addition, kappa carrageenan forms remarkably transparent gels, which gives excellent optical properties to the bioplastic composition.

Conveniently, the seaweed extract is derived from at least one seaweed belonging to the phylum Rhodophyta and from one of the genera selected from the list comprising: Gracilaria, Gelidiaceae, Kappaphycus, Mastocarpus, Euchema and Chondrus.

The aforementioned seaweeds are rich in gelling substances, such as agar and carrageenan.

As set forth above, the bioplastic composition also comprises additives. These additives have the function of modulating the properties of the bioplastic composition in order to give the latter the desired mechanical properties according to the type of bioplastic product desired to be obtained by means of the present bioplastic composition.

Conveniently, the bioplastic composition comprises:
at least one seaweed extract in a concentration by weight comprised between 40% and 70% with respect to the weight of the bioplastic composition;
water in a concentration by weight comprised between 5% and 25% with respect to the weight of the bioplastic composition;
at least four additives in a total concentration by weight comprised between 30% and 50% with respect to the weight of the bioplastic composition.

According to the invention, the additives comprise at least one plasticizer, at least one antimicrobial agent, at least one gelling agent and at least one adjuvant.

In particular, the plasticizer has the function of forming specific interactions with the chains of the seaweed extract and of forming gaps between them, which allow the polymer chain to move freely, resulting in greater flexibility in the bioplastic product.

The antimicrobial agent has the function of killing the microbial organisms or of slowing their growth down. The antimicrobial agents comprise antibacterial agents, antiviral agents, antifungal agents and anti-parasitic agents. The targeted application of such chemicals serves to preserve the integrity of the material to prevent premature degradation, as well as to extend the shelf life of both the product including this bioplastic composition and of any article contained therein. This is particularly important for food applications wherein the antimicrobial agents provide protection against mould and keep microbes away from food during production, transportation and storage.

The function of the gelling agent is to enable, accelerate or facilitate the formation of a gel cross-link, as well as to make it stronger and more resistant to various phases of production. In more detail, the gelling agent promotes physical and chemical cross-linkage, comprising ionic bonds, promotion of hydrogen bonds, and allows obtaining percolation, making the cross-link more stable and stronger overall.

The adjuvant has specific functions in relation to the type of bioplastic product to be obtained.

Specifically, the adjuvant is selected from the list comprising: water repellent agent, lipophilic agent, pH adjusting agent, emulsifying agent, flavouring agent, colouring agent, sweetener, antioxidant, filler, anti-wetting agent or sensory stimulating agent.

Advantageously, the additives comprise:
the plasticizer in a concentration by weight comprised between 50% and 95% with respect to the total weight of said additives;
the antimicrobial agent in a concentration by weight comprised between 0.01% and 30% with respect to the total weight of said additives;
the gelling agent in a concentration by weight comprised between 0.01% and 30% with respect to the total weight of said additives; and
the adjuvant in a concentration by weight comprised between 0.01% and 30% with respect to the total weight of said additives.

Conveniently, the plasticizer is selected from the list comprising: glycerol, sorbitol, mannitol, xylitol, propylene glycol, maltitol, erythritol, lactitol, sucrose, fructose, oxidized sucrose, maltose, glucose, glycerin, isomaltate, urea, choline, boric acid, borate, borax, uric acid, citric acid, acetic acid, sorbic acid, stearic acid, palmitic acid, glycerol triacetate, glycerol tricaprilate, monodiacetin, diacetin, triacetin.

According to a preferred embodiment of the present invention, the plasticizer is a polyol, preferably sorbitol.

Sorbitol allows for an increase in the free space between the chains and thus the workability of the gel and the flexibility of the resulting composition and of the products formed from it.

The composition comprises the plasticizer in a concentration by weight comprised between 50% and 95%, even more appropriately comprised between 60% and 85% by weight, with respect to the total weight of the additives.

Conveniently, the antimicrobial agent is selected from the list comprising: an inorganic salt, silver nanoparticles, titanium dioxide, zinc oxide, copper oxide, potassium hydroxide, sodium hydroxide, essential oils (e.g., vanilla, cinnamon, lemongrass, oregano, clove, turmeric), nisin, sorbic acid, boric acid, borate, borax.

The inorganic salt is selected from the list comprising: chloride of an alkaline or alkaline earth metal, sorbate of an alkaline or alkaline earth metal, acetate of an alkaline or alkaline earth metal, lactate of an alkaline or alkaline earth metal, nitrate of an alkaline or alkaline earth metal, citrate of an alkaline or alkaline earth metal, gluconate of an alkaline or alkaline earth metal.

According to a preferred embodiment of the present invention, the antimicrobial agent is an inorganic salt, preferably a sorbate of an alkaline or alkaline earth metal, even more preferably potassium sorbate.

Sorbate, preferably potassium sorbate, allows increasing the antibacterial properties and slow down the mold growth of the resulting composition and of the products derived therefrom.

According to an alternative embodiment, the antimicrobial agent is potassium nitrate.

The composition comprises the antimicrobial agent in a concentration by weight comprised between 0.01% and 30%, even more appropriately comprised between 0.5% and 20%, with respect to the total weight of the additives.

Advantageously, the gelling agent is selected from the list comprising: potassium hydroxide, sodium hydroxide, sodium bicarbonate, glutaraldehyde, vanillin, palmitic acid, citric acid, lactic acid, boron spirans, boric acid, borax, potassium tripolyphosphate, potassium persulfate, ferulic acid, an inorganic salt, chloride of an alkaline or alkaline earth metal, sorbate of an alkaline or alkaline earth metal, acetate of an alkaline or alkaline earth metal, lactate of an alkaline or alkaline earth metal, nitrate of an alkaline or alkaline earth metal, citrate of an alkaline or alkaline earth metal, gluconate of an alkaline or alkaline earth metal.

According to a preferred embodiment of the present invention, the gelling agent is a calcium salt, preferably calcium lactate. Indeed, the calcium salt, and preferably calcium lactate, enables ionic bonding of the polysaccharide chains in the proximity of their sulfated ends by increasing the gelling force of the resulting composition and of the products derived therefrom.

According to an alternative embodiment, the gelling agent is citric acid. Citric acid allows cross-linking the polysaccharide chains, thus increasing the mechanical strength of the resulting composition and of the products derived therefrom.

The composition comprises the gelling agent in a concentration by weight comprised between 0.01 and 30%, even more appropriately comprised between 0.5 and 20%, with respect to the total weight of the additives.

Conveniently, the adjuvant is selected from the list comprising: inorganic base (e.g., potassium hydroxide, sodium hydroxide and sodium bicarbonate), beeswax, lecithin, ferulic acid, vanillin, glutaraldehyde, boric acid, borax, hemp fiber, cellulosic derivatives, whey protein, sorbic acid, calcium chloride, genipin, epichlorohydrin, guar gum, palmitic acid, stearic acid, nisin, montmorillonite, a phyllosilicate, calcium carbonate, carbon nanotubes, succinic acid, potassium nitrate, potassium chloride, calcium propionate, sunflower seed lecithin, mica, clay, grapefruit seed extract.

According to a preferred embodiment of the present invention, the adjuvant is potassium hydroxide. Indeed, potassium hydroxide, in diluted solution 1:100 w/w, allows neutralizing the pH of the composition by preventing a possible hydrolysis of the polysaccharide chains during the preparation of the composition itself. The hydrolysis of polysaccharide chains, in fact, could compromise the mechanical strength of the biocompostable products obtained as well as involve an increase in toxicity caused by the presence of oligomers of the polysaccharide chains (especially oligomers weighing less than 50 kDa resulting from kappa carrageenan).

The composition comprises the adjuvant in a concentration by weight comprised between 0.01% and 30%, even more appropriately comprised between 0.01% and 20% with respect to the total weight of the additives.

Thanks to the presence of additives, the bioplastic composition has physical-mechanical characteristics similar to common plastic materials.

Advantageously, the bioplastic composition according to the invention is completely biodegradable.

This property is given by the great capacity to absorb water determined by the presence of the seaweed extract that encourages and facilitates the growth of microorganisms, such as bacteria or fungi, on the bioplastic product including the bioplastic composition and leading to the biodegradation thereof.

The rate of biodegradation varies, depending on exposure to humidity, from a few weeks, in case of complete immersion in water, up to one year, in low humidity conditions.

In more detail, the bioplastic composition according to the invention degrades completely in a time comprised between 8 weeks and 20 weeks.

Conveniently, the bioplastic composition is also fully compostable.

After being degraded, in fact, the composition generates substances that can be used as soil conditioners, i.e. which improve the physical characteristics of the soil.

In particular, the bioplastic composition according to the invention is effectively compostable even in home composting systems, i.e. without the need to use enzymes or chemicals adapted to this purpose and/or high treatment temperatures.

Even if dispersed in the environment, the bioplastic composition according to the invention degrades rapidly, is absorbed by the soil, in which it acts as a fertilizer, without generating micro/nano plastics, and does not alter the aquatic ecosystem.

In addition to that, the bioplastic composition is edible by animal organisms.

In fact, this bioplastic composition is also edible.

Specifically, the seaweeds and the corresponding seaweed extracts are substances also known in the food industry and the additives are selected from food additives approved by bodies such as EFSA or FDA.

Therefore, in view of the safety of the components of the composition and by the fact that the same is degradable even in the fluids of the digestive tract, it is expected that the composition is not dangerous for human and/or animal consumption, i.e., that the products including the composition itself are, at least in theory, edible.

According to a further aspect, the present invention also relates to a bioplastic product including at least one composition according to one or more of the embodiments described above.

The bioplastic product has a thickness comprised between 0.01 mm and 5 mm.

Products with greater thickness, i.e. more than 0.8 mm, can be used, e.g., as rigid or semi-rigid containers. Conversely, products with thickness of less than 0.8 mm can be used, e.g., as flexible packaging or films.

It should be specified that the degree of stiffness/flexibility of the bioplastic product varies not only as a function of thickness, but also as a function of the specific type of bioplastic composition used.

Preferably, the bioplastic product has a thickness comprised between 0.01 mm and 0.15 mm.

Advantageously, the bioplastic product is in the form of a thin film.

It should be noted that in the present disclosure the term “film” refers to a homogeneous layer of reduced and constant thickness.

In particular, the bioplastic composition according to the invention is easily shaped in the form of a thin film in order to make bioplastic products such as food films, sachets, bags, which are widely used as disposable materials and, when made from a conventional plastic material, are a major source of plastic pollution.

The bioplastic product, when in the form of a thin film, may be joined by sealing to other bioplastic products according to the invention. The joining can take place e.g. by heat sealing or steam sealing. Such a property enables the production, e.g. of sachets and bags and also allows them to be hermetically closed.

As an alternative to the thin film, the bioplastic product may have a shape selected from the list comprising: plane, flat sheet, sphere, spheroid, cube, cuboid, ellipse, ellipsoid, cylinder, cone, prism, pyramid or a combination thereof.

Conveniently, the product is selected from the list comprising: food container, packaging material, film, sheet, straw, tube, tampon and applicator, cutlery, dish, tray, shaker, bag, sachet, shopper.

The product may also comprise at least one decorated portion.

For example, the decorated portion may comprise a chromatic decoration, made using natural and/or biodegradable inks and obtained by means of a digital printing device and/or a structured decoration, i.e., having reliefs and recesses, obtained by means of special three-dimensional molds.

According to a further aspect, the present invention relates to a production process of a bioplastic product.

The process first comprises a phase of supply of one or more seaweed extracts.

In particular, the seaweed extracts are in the form of dry extracts. In greater detail, the seaweed extracts are in powder form.

The process also comprises a phase of supply of at least four additives.

The process then provides for a phase of hydration of the one or more seaweed extracts and additives with water to obtain a solution.

Preferably, the water is in an amount comprised between 5 and 50 times by weight with respect to the total weight of the seaweed extract and additives.

Preferably, the water is in an amount comprised between 15 and 30 times by weight with respect to the total weight of the seaweed extract and additives.

Conveniently, the phase of hydration is carried out at a temperature comprised between 10° C. and 95° C.

Preferably, the phase of hydration is carried out at a temperature above 40° C.

The process then comprises a phase of mixing the solution to obtain a homogeneously dispersed working mixture.

Conveniently, the phase of mixing comprises a step of heating the working mixture up to a temperature comprised between 85° C. and 100° C., preferably comprised between 95° C. and 100° C.

During mixing, the pH is possibly neutralized by means of a pH-regulating adjuvant. As described above, maintaining a neutral pH allows avoiding hydrolysis of the polysaccharide chains constituting the seaweed extract and possible toxic effects caused by the by-products of such hydrolysis.

The phase of mixing is carried out for a time comprised between 30 minutes and 90 minutes, preferably for 60 minutes.

The phase of mixing may also comprise a degassing step. This step allows removing any air bubbles formed during the process, which could compromise the homogeneity of the bioplastic composition and the relevant mechanical properties.

Next, the process comprises a phase of forming the working mixture according to a desired shape.

The phase of forming is carried out at a temperature higher than 65° C. in order to ensure an optimal workability of the working mixture. At lower temperatures, in fact, initial gelling may occur which would make the mixture excessively viscous and would not allow proper forming.

According to a preferred embodiment, the phase of forming is carried out by spreading the working mixture on a working surface to obtain at least one layer.

Preferably, the aforementioned layer is of the type of a thin film.

The spreading of the mixture may be substantially on a continuous or discontinuous basis.

In the first case, the working surface may be, e.g., of the type of a conveyor belt, movable forward in a direction of forward movement as the mixture is distributed thereon. The resulting bioplastic product is, then, a film in the form of a continuous belt and can be organized in rolls and portioned when needed.

Conveniently, these rolls can be fitted on packaging machines of a type known to the industry technician to enable the packaging of items.

In the second case, on the other hand, the working surface comprises, e.g., a flat forming mold and the bioplastic product obtained is a film in the form of sheets of dimensions corresponding to the dimensions of the forming mold itself.

According to an alternative embodiment, the phase of forming is carried out by pressure molding, injection molding, casting. These techniques make it possible to obtain bioplastic products of complex shapes and with suitable thicknesses to allow the maintenance of these shapes.

The bioplastic products that are obtained are, therefore, of the type of containers or of the type of other three-dimensional objects as described above.

Preferably, the phase of forming is carried out by casting in special molds.

Finally, the process comprises a phase of solidification of the mixture to obtain the bioplastic product.

The phase of solidification initially comprises a step of cooling the working mixture.

Lowering the temperature allows the working mixture to gel and compact in order to form a hydrogel.

Specifically, cooling may be natural, i.e. carried out at room temperature, or artificial, through the use of cooling means, in order to speed up such process.

In particular, it would be suitable that the temperature of the hydrogel drops below 40° C.

Thereafter, the phase of solidification comprises a step of drying the hydrogel to obtain the bioplastic product.

The drying phase can be carried out by evaporation of the residual moisture at room temperature, by heating to temperatures below 65° C. or by means of the use of sequestering substances.

Preferably, the phase of solidification is carried out using infrared lamps under ventilation.

The bioplastic product comprises water content comprised between 5% and 25% with respect to the total weight.

Two examples of the execution of the process according to the invention are given below.

### Example 1

Kappa carrageenan (3 g, powdered), Agar (1 g, powdered), potassium sorbate (0.3 g), calcium lactate (0.1 g) and sorbitol (7 g) are added to 250 g of preheated water (70° C.) and then mixed for 15 minutes. The resulting solution is heated to 90° C. using a heating stirring plate. During heating, the pH is checked and regulated to a value of approx. 7 with a sodium hydroxide solution 1:100 w/w.

The mixture is kept under stirring at 90° C. for 60 minutes.

The mixture is poured onto a silicone surface with removable edges, measuring 40×40 cm, and allowed to dry and solidify at room temperature to obtain a layer of transparent gel, then the edges are removed.

The layer of gel and the silicone surface are placed in a ventilated oven at 50° C. for 4 h. The obtained film is then removed from the silicone surface.

The resulting film has a water content of 18% of the total weight of the film.

### Example 2

Kappa carrageenan (3 g, powdered), citric acid (0.2 g), potassium nitrate (0.05 g), and mannitol (3 g) are added to 100 g of preheated water (70° C.) and then mixed for 15 minutes. The resulting solution is heated to 90° C. using a heating stirring plate. During heating, the pH is checked and regulated to a value of approx. 7 with a potassium hydroxide solution 1:100 w/w. The mixture is kept under stirring at 90° C. for 60 minutes.

The mixture is poured onto a glass surface with removable edges, measuring 40×40 cm, and allowed to dry and solidify at room temperature to obtain a layer of transparent gel, then the edges are removed.

The layer of gel and the glass surface are placed under infrared lamps at 60° C. for 2.5 h. The resulting film is then allowed to rehydrate for 60 minutes and then removed from the glass surface.

The resulting film has a water content of 15% of the total weight of the film.

It has in practice been ascertained that the described invention achieves the intended objects and, in particular, the fact is emphasized that the bioplastic composition has physical-mechanical properties comparable to those of conventional plastic materials, thanks to the specific synergistic combinations between the seaweed extract and the additives.

Moreover, the components of the present bioplastic composition make it easily biodegradable and compostable in nature thus avoiding industrial processes.

Again, the present bioplastic composition enables the manufacture of bioplastic products that are both durable and safe for the bioplastic consumer. In particular, the bioplastic composition according to the invention is easily molded in the form of a thin film in order to make food films, sachets, bags, which are widely used as disposable materials and represent one of the main sources of plastic pollution.

Finally, the present bioplastic composition is obtainable through a production process which does not involve the use of toxic chemicals, solvents or special conditions, making it low environmental impact, environmentally sustainable and reproducible on a large scale.

1. Bioplastic composition comprising:
at least one seaweed extract in a concentration by weight comprised between 30% and 80% with respect to the weight of the bioplastic composition;
water in a concentration by weight comprised between 1% and 30% with respect to the weight of the bioplastic composition;
at least four additives present in a total concentration by weight comprised between 20% and 70% with respect to the weight of the bioplastic composition;
wherein said additives comprise at least one plasticizer, at least one antimicrobial agent, at least one gelling agent and at least one adjuvant.

2. Composition according to claim 1, wherein it comprises:
said at least one seaweed extract in a concentration by weight comprised between 40% and 70% with respect to the weight of the bioplastic composition;
said water in a concentration by weight comprised between 5% and 25% with respect to the weight of the bioplastic composition;
said at, least four additives in a total concentration by weight comprised between 30% and 50% with respect to the weight of the bioplastic composition.

3. Composition according to claim 1, wherein said additives comprise:
said plasticizer in a concentration by weight comprised between 50% and 95% with respect to the total weight of said additives;
said antimicrobial agent in a concentration by weight comprised between 0.01% and 30% with respect to the total weight of said additives;
said gelling agent in a concentration by weight comprised between 0.01% and 30% with respect to the total weight of said additives; and
said adjuvant in a concentration by weight comprised between 0.01% and 30% with respect to the total weight of said additives.

4. Composition according to claim 1, wherein said at least one seaweed extract comprises at least one of: carrageenan, agar, alginate, fucoidan or a combination thereof.

5-8. (canceled)

9. Composition according to claim 1, wherein said plasticizer is selected from the list comprising: glycerol, sorbitol, mannitol, xylitol, propylene glycol, maltitol, erythritol, lactitol, sucrose, fructose, oxidized sucrose, maltose, glucose, glycerin, isomaltate, urea, choline, boric acid, borate, borax, uric acid, citric acid, acetic acid, sorbic acid, stearic acid, palmitic acid, glycerol triacetate, glycerol tricaprilate, monodiacetin, diacetin, triacetin.

10. (canceled)

11. Composition according to claim 1, wherein said antimicrobial agent is selected from the list comprising: an inorganic salt, silver nanoparticles, titanium dioxide, zinc oxide, copper oxide, potassium hydroxide, sodium hydroxide, essential oils, nisin, sorbic acid, boric acid, borate, borax.

12. Composition according to claim 1, wherein said inorganic salt is selected from the list comprising: chloride of an alkaline or alkaline earth metal, sorbate of an alkaline or alkaline earth metal, acetate of an alkaline or alkaline earth metal, lactate of an alkaline or alkaline earth metal, nitrate of an alkaline or alkaline earth metal, citrate of an alkaline or alkaline earth metal, gluconate of an alkaline or alkaline earth metal.

13. (canceled)

14. Composition according to claim 1, wherein said gelling agent is selected from the list comprising: inorganic base, glutaraldehyde, vanillin, palmitic acid, citric acid, lactic acid, boron spirans, boric acid, borax, organic calcium, tripolyphosphate potassium, persulfate potassium, ferulic acid, an inorganic salt.

15. (canceled)

16. Composition according to claim 1, wherein said gelling agent is calcium lactate.

17. Composition according to claim 1, wherein said adjuvant is selected from the list comprising: water repellent agent, lipophilic agent, pH regulating agent, emulsifying agent, flavoring agent, coloring agent, sweetener, antioxidant, filler, anti-moistening agent or sensory stimulating agent.

18. Composition according to claim 1, wherein said adjuvant is selected from the list comprising: potassium hydroxide, sodium hydroxide, sodium bicarbonate, beeswax, lecithin, ferulic acid, vanillin, glutaraldehyde, boric acid, borax, hemp fiber, cellulosic derivatives, whey protein, sorbic acid, calcium chloride, genipin, epichlorohydrin, guar gum, palmitic acid, stearic acid, nisin, montmorillonite, a phyllosilicate, calcium carbonate, carbon nanotubes, succinic acid, potassium nitrate, potassium chloride, calcium propionate, sunflower seed lecithin, mica, clay, grapefruit seed extract.

19-22. (canceled)

23. Bioplastic product comprising at least one composition according to claim 1.

24. Bioplastic product according to claim 23, wherein it has a thickness comprised between 0.01 mm and 5 mm, preferably between 0.01 mm and 0.15 mm.

25. Bioplastic product according to claim 24, wherein said bioplastic product is in the form of in film.

26. Bioplastic product according to claim 24, wherein said product has a shape selected from the list comprising: plane, flat sheet, sphere, spheroid, cube, cuboid, ellipse, ellipsoid, cylinder, cone, prism, pyramid, a combination thereof.

27. Bioplastic product according to claim 23, wherein said product is selected from the list comprising: food container, packaging material, film, sheet, straw, tube, cutlery, dish, tray, shaker, sachet, bag, shopper.

28. Production process of a bioplastic product according to claim 23, comprising the phases of:
supply of one or more seaweed extracts;
supply of at least four additives;
hydration of said one or more seaweed extracts and of said additives with water to obtain a solution;
mixing of said solution to obtain a homogeneously dispersed working mixture;
forming of said working mixture according to a desired shape; solidification of said working mixture to obtain said bioplastic product.

29. Process according to claim 28, wherein said water is in an amount comprised between 5 and 50 times with respect to the total weight of said seaweed extract and said additives, preferably comprised between 15 and 30 times.

30. Process according to claim 28, wherein said hydration is carried out at a temperature comprised between 10° C. and 95° C.

31-33. (canceled)

34. Process according to claim 28, wherein said forming is carried out by pressure moulding, injection molding, casting.
